(19) United States
(12) Patent Application Publication
(10) Pub. No.: US 2014/0004941 A1
(43) Pub. Date: Jan. 2, 2014

(54) CONVERSION OF HAPTIC EVENTS INTO SCREEN EVENTS

(71) Applicants: Brian Michael Christopher Watson, Burlingame, CA (US); Victor Octav Suba Miura, Foster City, CA (US)

(72) Inventors: Brian Michael Christopher Watson, Burlingame, CA (US); Victor Octav Suba Miura, Foster City, CA (US)

(73) Assignee: Sony Computer Entertainment Inc., Tokyo (JP)

(21) Appl. No.: 13/791,420

(22) Filed: Mar. 8, 2013

Related U.S. Application Data
(60) Provisional application No. 61/666,665, filed on Jun. 29, 2012.

(51) Int. Cl. A63F 13/02

(52) U.S. Cl. CPC A63F 13/02
USPC 463/31

(57) ABSTRACT

Embodiments of the present invention describe the addition of a screen event stimulus to emulated legacy game data when a haptic stimulus is present in the emulated legacy game data. The client device platform may then use the screen event stimulus to generate a screen event when the game is displayed on the display unit of the client device platform. This invention enables a client device platform to provide a visual representation of the haptic information that may not be able to be otherwise communicated to the game player. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### CLAIM OF PRIORITY

This application is a nonprovisional of commonly-assigned U.S. Provisional Patent Application No. 61/666,665 filed Jun. 29, 2012, the entire disclosures of which are incorporated herein by reference.

### Cross-Reference to Related Application

This application is related to commonly-assigned, co-pending provisional application No. 61/666,628, and entitled “DETERMINING TRIGGERS FOR CLOUD-BASED EMULATED GAMES” (Attorney Docket Number SCEA12004US00), filed Jun. 29, 2012, the entire disclosures of which are incorporated herein by reference.

This application is related to commonly-assigned, co-pending provisional application No. 61/666,645, and entitled “HAPTIC ENHANCEMENTS FOR EMULATED VIDEO GAME NOT ORIGINALLY DESIGNED WITH HAPTIC CAPABILITIES” (Attorney Docket Number SCEA12005US00), filed Jun. 29, 2012, the entire disclosures of which are incorporated herein by reference.

This application is related to commonly-assigned, co-pending provisional application No. 61/666,679 entitled “SUSPENDING STATE OF CLOUD-BASED LEGACY APPLICATION”, (Attorney Docket Number SCEA12007US00) to Victor Suba Miura et al, Jun. 29, 2012, the entire disclosures of which are incorporated herein by reference.

### FIELD OF THE DISCLOSURE

This disclosure relates to a method and apparatus for video game emulation. Among other things, this disclosure describes a method and apparatus for inserting screen events stimulus into emulated game data when there is a haptic stimulus present.

### BACKGROUND OF THE INVENTION

Haptic feedback is a tactile feedback mechanism that utilizes the sense of touch. When used in conjunction with a control system the tactile feedback provides sensory cues to the user which indicates a certain event is happening to the object being controlled. For example, in an airplane simulation, the addition of haptic feedback to a joystick controller in the form of vibrations allows the user to more easily perceive the turbulence.

In a controller, an electrical stimulus activates an actuator which then provides mechanical motion to the controller. The mechanical motion is often vibratory. Early haptic feedback systems utilized electromagnetic technologies that moved a central mass with an applied magnetic field. Newer technologies such as electroactive polymers, piezoelectric, electrostatic and subsonic audio wave surface actuation can be used to create haptic feedback as well. These technologies allow for a more dynamic range of sensations to be produced.

In video games and simulators, haptic feedback has become a common addition to controllers. The haptic feedback capabilities in devices like Sony Computer Entertainment's Dual Shock family of controllers provide a more immersive gaming experience. However, not all gaming systems utilize controllers that can produce haptic feedback. For example, games played on a computer with the use of a keyboard and a mouse often do not support haptic feedback. Additionally, controllers that can generate haptic feedback may have their haptics functionality disabled by the user or they may be broken. Therefore, a controller may not have the haptic functionality envisioned by the game's original designer when legacy games are emulated for playback on different systems then the one they were originally designed for.

Therefore, there is a need in the art to provide a game player who does not receive haptic feedback from their controller a way to visually perceive when haptic feedback would otherwise be generated without having to alter the code of a legacy game.

### BRIEF DESCRIPTION OF THE DRAWINGS

FIG. 1A is a schematic diagram of a client device platform and an emulator communicating over a network according to an aspect of the present disclosure.

FIG. 1B is a prior art block diagram describing the response of a client device platform receiving a haptic stimulus.

FIG. 1C is a block diagram describing the response of a client device platform receiving a screen event stimulus instead of a haptic stimulus according to an aspect of the present disclosure.

FIG. 1D is a block diagram describing the response of a client device platform receiving a screen event stimulus and a haptic stimulus according to an additional aspect of the present disclosure.

FIG. 2 is a flow diagram illustrating a method of adding haptics to an emulated game according to an aspect of the present disclosure.

FIG. 3A is a block diagram describing the instructions for how a client device platform displays screen event stimulus in an emulated game according to an aspect of the present disclosure.

FIG. 3B is a block diagram describing the instructions for how an emulator inserts a screen event stimulus when a haptic stimulus is identified while emulating a game according to an aspect of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the aspects of the present disclosure described below are set forth without any loss of generality to, and without imposing limitations upon, the claims that follow this description.

According to an embodiment of the present invention, when a controller is not capable of generating a haptic response the emulator inserts a screen event stimulus into the emulated game data. The client device platform may then use the screen event stimulus to generate a screen response when the game is displayed on a display unit.

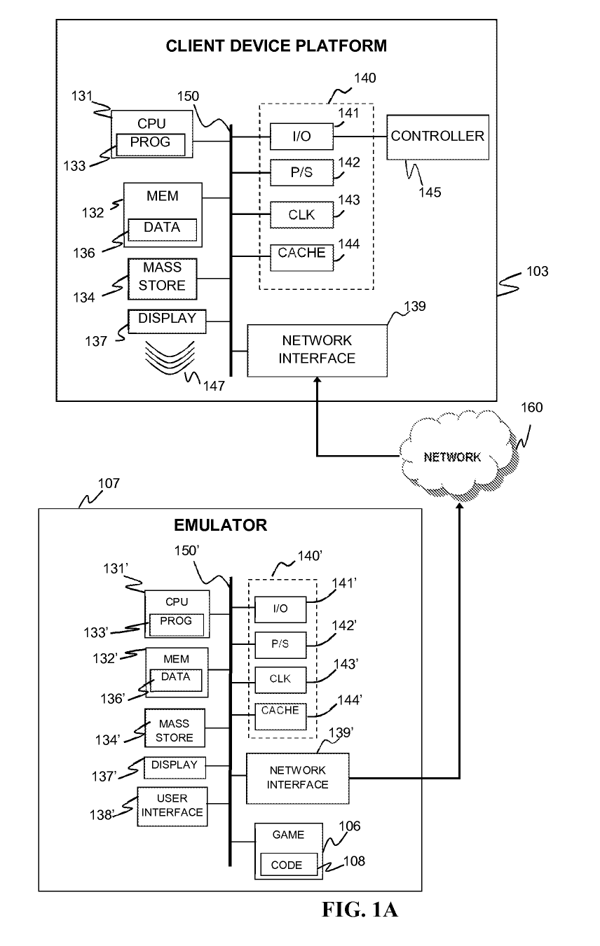

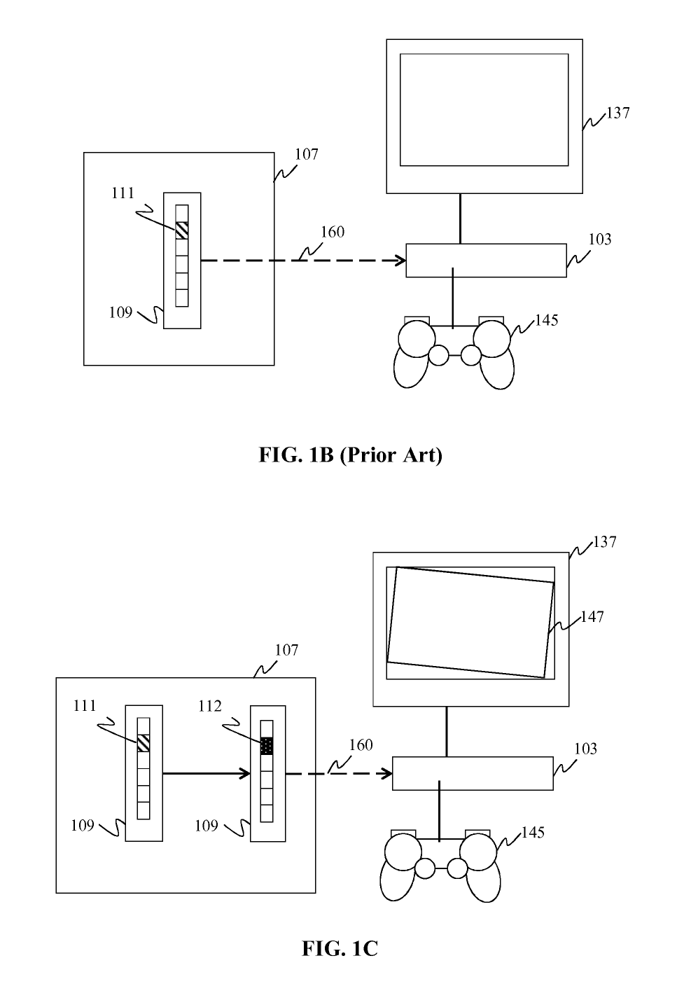

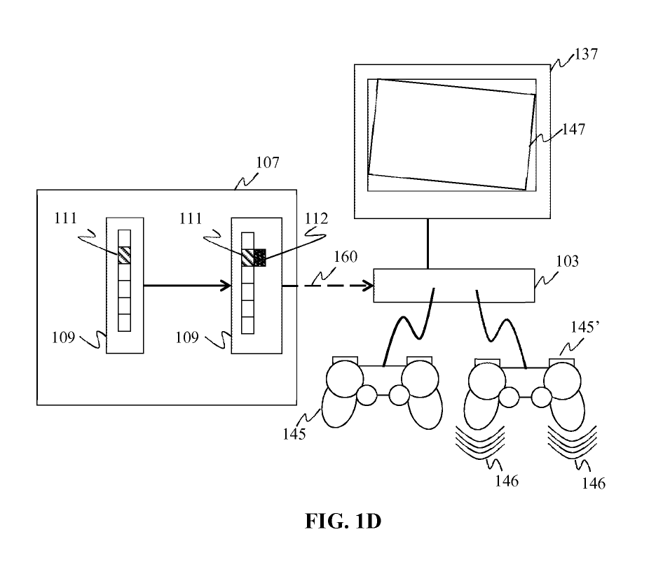

FIG. 1A is a schematic of an embodiment of the present invention. Emulator 107 may be accessed by a client device platform 103 over a network 160. Client device platform 103 may be one of a plurality of client device platforms 103 that are each able to access the same emulator 107 over the network 160. Client device platform 103 may also access alternative emulators 107.

Client device platform 103 may include a central processor unit (CPU) 131. By way of example, a CPU 131 may include one or more multiple core processors, e.g., a dual-core, quad-core or Cell processors. The client device platform 103 may also include a memory 132 (e.g., RAM, DRAM, ROM, and the like). The CPU 131 may execute a process-control program 133, portions of which may be stored in the memory 132. The client device platform 103 may also include well-known support circuits 140, such as input/output (I/O) circuits 141, power supplies (P/S) 142, a clock (CLK) 143 and cache 144. The client device platform 103 may optionally include a mass storage device 134 such as a disk drive, CD-ROM drive, tape drive, or the like to store programs and/or data. The client device platform 103 may also optionally include a display unit 137. The display unit 137 may be in the form of a cathode ray tube (CRT) or flat panel screen that displays text, numerals, or graphical symbols. The display unit 137 may also be capable of displaying a screen event 147. By way of example and not by way of limitation, a screen event 147 may be a brief wiggle of the image on the screen, blurring the image on the screen, a temporary change in the brightness or contrast of an image on the screen or any other temporary alteration or combination of alterations to the image on the screen.

A controller 145 may be connected to the client device platform 103 through the I/O circuit 141 or it may be directly integrated into the client device platform 103. The controller 145 may facilitate interaction between the client device platform 103 and a user. The controller 145 may include a keyboard, mouse, joystick, light pen, hand-held controls or other device. According to embodiments of the present invention the controller 145 may not be capable of producing a haptic response 146. By way of example and not by way of limitation, the controller 145 may completely lack the ability to produce a haptic response 146, or the controller 145 may have the ability to produce a haptic response 146, but the feature has been switched off by the user or is broken.

The client device platform 103 may include a network interface 139, configured to enable the use of Wi-Fi, an Ethernet port, or other communication methods. The network interface 139 may incorporate suitable hardware, software, firmware or some combination of two or more of these to facilitate communication via an electronic communications network 160. The network interface 139 may be configured to implement wired or wireless communication over local area networks and wide area networks such as the Internet. The client device platform 103 may send and receive data and/or requests for files via one or more data packets over the network 160.

The preceding components may exchange signals with each other via an internal system bus 150. The client device platform 103 may be a general purpose computer that becomes a special purpose computer when running code that implements embodiments of the present invention as described herein.

The emulator 107 may include a central processor unit (CPU) 131′. By way of example, a CPU 131′ may include one or more multiple core processors, e.g., a dual-core, quad-core or Cell processors. The emulator 107 may also include a memory 132′ (e.g., RAM, DRAM, ROM, and the like). The CPU 131′ may execute a process-control program 133′, portions of which may be stored in the memory 132′. The emulator 107 may also include well-known support circuits 140′, such as input/output (I/O) circuits 141′, power supplies (P/S) 142′, a clock (CLK) 143′ and cache 144′. The emulator 107 may optionally include a mass storage device 134′ such as a disk drive, CD-ROM drive, tape drive, or the like to store programs and/or data. The emulator 107 may also optionally include a display unit 137′ and user interface unit 138′ to facilitate interaction between the emulator 107 and a user who requires direct access to the emulator 107. The display unit 137′ may be in the form of a cathode ray tube (CRT) or flat panel screen that displays text, numerals, or graphical symbols. The user interface unit 138′ may include a keyboard, mouse, joystick, light pen, or other device. The emulator 107 may include a network interface 139′, configured to enable the use of Wi-Fi, an Ethernet port, or other communication methods.

The network interface 139′ may incorporate suitable hardware, software, firmware or some combination of two or more of these to facilitate communication via the electronic communications network 160. The network interface 139′ may be configured to implement wired or wireless communication over local area networks and wide area networks such as the Internet. The emulator 107 may send and receive data and/or requests for files via one or more data packets over the network 160.

The preceding components may exchange signals with each other via an internal system bus 150′. The emulator 107 may be a general purpose computer that becomes a special purpose computer when running code that implements embodiments of the present invention as described herein.

Emulator 107 may access a legacy game 106 that has been selected by the client device platform 103 for emulation through the internal system bus 150′. There may be more than one legacy game 106 stored in the emulator. The legacy games 106 may also be stored in the memory 132′ or in the mass storage device 134′. Additionally, one or more legacy games 106 may be stored at a remote location accessible to the emulator 107 over the network 160. Each legacy game 106 contains game code 108. When the legacy game 106 is emulated, the emulator 107 uses the game code 108 to produce emulated legacy game data 109.

By way of example, a legacy game 106 may be any game that is not compatible with the client device platform 103. By way of example and not by way of limitation, the legacy game 106 may have been designed to be played on Sony Computer Entertainment's PlayStation console, but the client device platform 103 is a home computer. By way of example, the legacy game 106 may have been designed to be played on a PlayStation 2 console, but the client device platform 103 is a PlayStation 3 console. Further, by way of example and not by way of limitation, a legacy game 106 may have been designed to be played on a PlayStation console, but the client device platform 103 is a hand held console such as the PlayStation Vita from Sony Computer Entertainment.

FIG. 1B is a block diagram of a system according to the prior art. The client device platform 103 is receiving emulated legacy game data 109 from the emulator 107 over the network connection 160. Within the emulated legacy game data 109 is a haptic stimulus 111 which is generally used to produce a haptic response 146 in the client device platform 103. However, in this diagram, controller 145 is not capable of producing a haptic response 146. Therefore, the haptic stimulus 111 is ignored by the client device platform 103. By missing the haptic response 146, the user playing the legacy game 106 is not provided with the same gaming experience as envisioned by the designer of the legacy game 106.

FIG. 1C is a block diagram of a system similar to that in FIG. 1B, with the exception of emulated legacy game data 109. Here, according to an embodiment of the present invention the emulator 107 detects that there is a haptic stimulus 111 in the emulated legacy game data 109, and replaces the haptic stimulus 111 with a screen event stimulus 112. By way of example and not by way of limitation, the emulator 107 may replace the haptic stimulus 111 by first deleting the haptic stimulus 111 and then generating a screen event stimulus 112 that will be inserted into the emulated legacy game data 109. Also by way of example, the screen event stimulus 112 may be inserted into the emulated legacy game data 109 before haptic stimulus 111 is removed from the legacy game data. The emulated legacy game data 109 and the screen event stimulus 112 are then delivered to the client device platform 103 over the network 160. The client device platform 103 is then able to utilize the information in the emulated legacy game data 109 to display the screen event 147 on the display unit 137. By way of example, and not by way of limitation, FIG. 1C describes the screen event 147 as a wiggling of the displayed image. However, it should be noted that screen event 147 may also be a blurring of the image on the screen, a temporary change in the brightness or contrast of the image on the screen or any other temporary alteration or combination of alterations to the image on the screen. Therefore, the user playing the game will have a gaming experience more similar to the one envisioned by the game designer.

FIG. 1D provides an additional embodiment of the present invention. The client device platform 103 is receiving emulated legacy game data 109 from the emulator 107 over the network connection 160. According to this embodiment, the client device platform comprises at least one controller 145 that cannot generate a haptic response 146 and at least one controller 145′ that can generate a haptic response 146. Therefore, it is desirable to enable controller 145′ to receive the haptic stimulus 111, while still inserting a screen event stimulus 112 so the user with the controller 145 may visually perceive the haptic response 146. Within the emulated legacy game data 109 is a haptic stimulus 111 which is generally used to produce a haptic response 146 in the client device platform 103. However, in this diagram, controller 145 is not capable of producing a haptic response 146. Therefore, the emulator 107 may insert a screen event stimulus 112 into the emulated legacy game data 109. Since there is still a controller 145′ that can utilize the haptic stimulus 111 it is not removed and both the haptic stimulus 111 and the screen event stimulus 112 are delivered to the client device platform 103. The client device platform 103 uses the screen event stimulus to produce the screen event 147. By way of example, and not by way of limitation, FIG. 1D describes the screen event 147 as a wiggling of the displayed image. However, it should be noted that screen event 147 may also be a blurring of the image on the screen, a temporary change in the brightness or contrast of the image on the screen or any other temporary alteration or combination of alterations to the image on the screen. Additionally, the client device platform 103 uses the haptic stimulus to produce the haptic response 146 in the controller 145′ that is capable of producing haptic feedback.

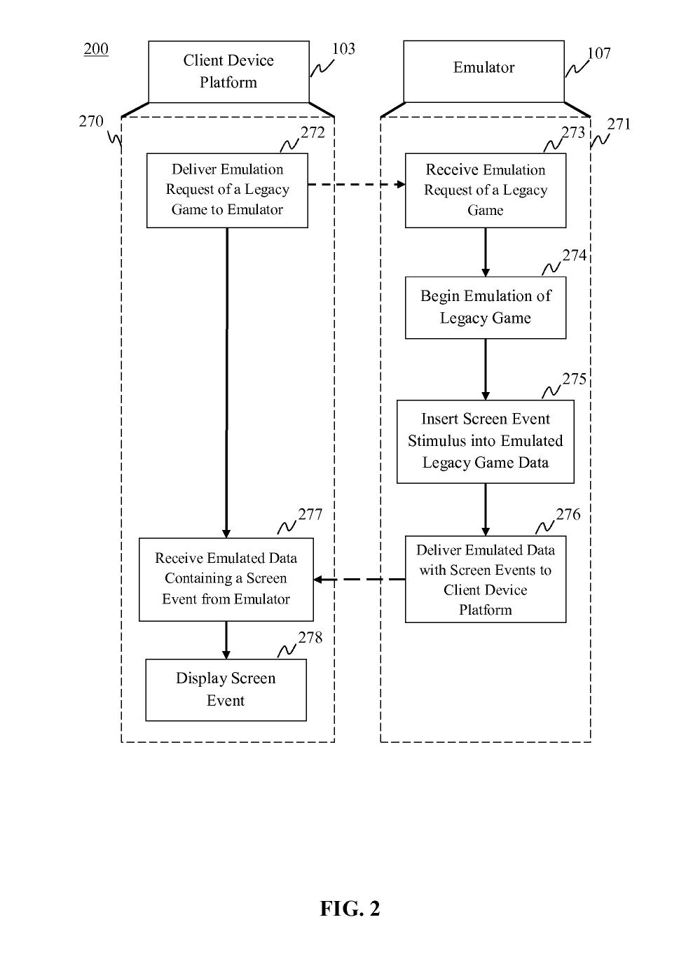

As shown in FIG. 2, the client device platform 103 and the emulator 107 may be configured to implement a method for inserting a screen event stimulus 112 into the emulated legacy game data 109 when the client device platform is not able to generate a haptic response according to an inventive method 200. Various aspects of the method 200 may be implemented by execution of computer executable instructions running on the client device platform 103 and/or the emulator 107. Specifically, a client device platform 103 may be configured, e.g., by suitable programming, to implement certain client device platform instructions 270. In addition, an emulator 107 may be configured to implement certain emulation instructions 271. In FIG. 2 the dashed arrows represent the flow of data between the client device platform 103 and the emulator 107 over the network 160.

Initially, at 272 the client device platform 103 may deliver information to the emulator 107 indicating that the user has selected a legacy game 106 that he wants emulated. Additionally, the emulation request may also include information that indicates to the emulator 107 that the client device platform 103 does not support haptic responses 146. The emulator 107 receives this information at block 273 and then proceeds to emulate the chosen legacy game 106 at 274. While emulating the legacy game 106, the emulator 107 will check the emulated legacy game data 109 for haptic stimulus 111 at 275. If a haptic stimulus 111 is found, the emulator 107 will insert a screen event stimulus 112. By way of example and not by way of limitation, inserting the screen event stimulus 112 may include having the emulator 107 replace the haptic stimulus 111 by first deleting the haptic stimulus 111 and then generating a screen event stimulus 112 that will be inserted into the emulated legacy game data 109. Also by way of example, inserting the screen event stimulus 112 may include inserting the screen event stimulus 112 into the emulated legacy game data 109 before the haptic stimulus 111 is removed from the legacy game data. Further, by way of example, inserting the screen event stimulus 112 may include inserting the screen event stimulus 112 into the emulated legacy data 109 and not removing the haptic stimulus 111 from the emulated legacy game data 109. At 276, the emulated legacy game data 109 which now contains the screen event stimulus 112 is sent to the client device platform 103 over the network connection 160. The client device platform 103 receives the emulated legacy game data 109 containing the screen event stimulus at 277, and then utilizes the screen event stimulus 112 to display the screen event 147 at 278.

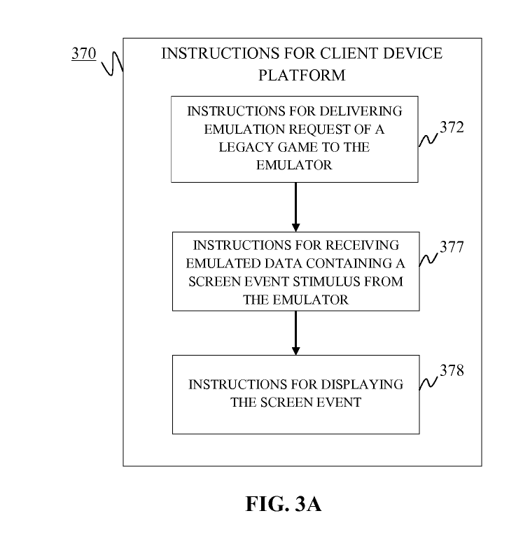

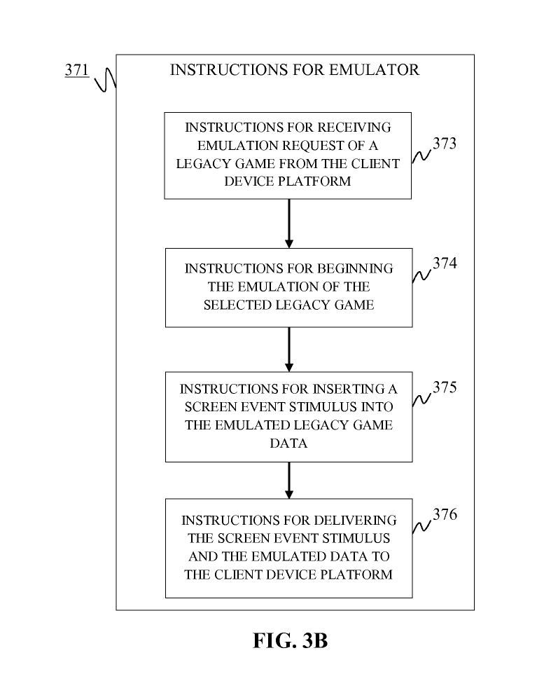

As shown in FIG. 3A, a set of client device platform instructions 370 may be implemented, e.g., by the client device platform 103. The client device platform instructions 370 may be formed on a nontransitory computer readable medium such as the memory 132 or the mass storage device 134. The client device platform instructions 370 may also be part of the process control program 133. At 372, the instructions may include delivering information to the emulator 107 indicating that the user has selected a legacy game 106 that he wants emulated. Additionally at 372, the instructions may also include instructions for sending information that indicates to the emulator 107 that the client device platform 103 does not support haptic responses 146. Thereafter, the client device platform instructions 370 may include instructions for the client device platform 103 to receive both the emulated legacy game data 109 and a screen event stimulus 112 from the emulator at 377. At 378, the client device platform 103 may be instructed to use the screen event stimulus 112 to produce a screen event 147 when the client device platform 103 displays the legacy game data 109 on the display device 137.

As shown in FIG. 3B, a set of emulator instructions 371 may be implemented, e.g., by the emulator 107. The emulation instructions 371 may be formed on a nontransitory computer readable medium such as the memory 132′ or the mass storage device 134′. The emulator instructions 371 may also be part of the process control program 133′. At 373, the emulator instructions 371 may include instructions for receiving information from the client device platform 103 indicating that the user has selected a legacy game 106 that he wants emulated. Additionally at 373, the emulator instructions 371 may include instructions for receiving information that the client device platform 103 does not support haptic responses 146. Thereafter the emulator instructions 371 may include instructions for the emulator 107 to begin emulating the selected legacy game 106 at 374. At 375, instructions for emulating the legacy game 106 may include instructions to check the emulated legacy game data 109 for haptic stimulus 111, and inserting a screen event stimulus 112 whenever a haptic stimulus 111 is present within the emulated legacy game data 109. By way of example and not by way of limitation, inserting the screen event stimulus 112 may include having the emulator 107 replace the haptic stimulus 111 by first deleting the haptic stimulus 111 and then generating a screen event stimulus 112 that will be inserted into the emulated legacy game data 109. Also by way of example, inserting the screen event stimulus 112 may include inserting the screen event stimulus 112 into the emulated legacy game data 109 before the haptic stimulus 111 is removed from the legacy game data. Further, by way of example, inserting the screen event stimulus 112 may include inserting the screen event stimulus 112 into the emulated legacy data 109 and not removing the haptic stimulus 111 from the emulated legacy game data 109. The emulator 107 may have instructions for then instructed to deliver the emulated legacy game data 109 and the screen event stimulus 112 to the client device platform at 376.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. In an emulator configured to operate on a network, a method for inserting a screen event stimulus into a set of emulated data, comprising:
a) receiving an emulation request for a game from a client device platform;
b) generating a set of emulated data while emulating the game;
c) inserting a screen event stimulus into the set of emulated data for each instance of a haptic stimulus within the set of emulated data; and
d) delivering the set of emulated data containing the screen event stimulus to the client device platform.

2. The method of claim 1, wherein at c) further includes deleting the haptic stimulus from the set of emulated data.

3. The method of claim 2, wherein the haptic stimulus is deleted from the set of emulated data before the screen event stimulus is inserted into the set of emulated data.

4. The method of claim 2, wherein the screen event stimulus is inserted into the set of emulated data before the haptic stimulus is deleted from the set of emulated data.

5. The method of claim 1, wherein a) further includes receiving information from the client device platform that indicates at least one of one or more controllers is not configured to generate a haptic response.

6. The method of claim 1, wherein the game is stored in a memory component of the emulator.

7. The method of claim 1, wherein the game is stored at a remote location accessible to the emulator over the network.

8. The method of claim 1, wherein the screen event stimulus is configured to cause the client device platform to alter a displayed image.

9. The method of claim 8, wherein the displayed image is altered by being wiggled.

10. The method of claim 8, wherein the displayed image is altered by changing the brightness.

11. The method of claim 8, wherein the displayed image is altered by changing the contrast.

12. The method of claim 8, wherein the displayed image is altered by blurring the image.

13. The method of claim 1, wherein the emulation request is received over a network connection.

14. The method of claim 13, wherein the network connection is a wireless connection.

15. The method of claim 13, wherein the network is a wired connection.

16. The method of claim 13, wherein the network is a local area network.

17. The method of claim 13, wherein the network is a wide area network.

18. A nontransitory computer readable medium containing program instructions for inserting a screen event stimulus into a set of emulated data, and wherein execution of the program instructions by one or more processors of a computer system causes the one or more processors to carry out the steps of:
a) receiving an emulation request for a game from a client device platform;
b) generating a set of emulated data while emulating the game;
c) inserting a screen event stimulus into the set of emulated data for each instance of a haptic stimulus within the set of emulated data; and
d) delivering the set of emulated data containing the screen event stimulus to the client device platform.

19. An emulator configured to operate on a network, comprising:
a processor;
a memory coupled to the processor;
one or more instructions embodied in memory for execution by the processor, the instructions being configured to implement a method inserting a screen event stimulus into a set of emulated data, the method comprising:
a) receiving an emulation request for a game from a client device platform;
b) generating a set of emulated data while emulating the game;
c) inserting a screen event stimulus into the set of emulated data for each instance of a haptic stimulus within the set of emulated data; and
d) delivering the set of emulated data containing the screen event stimulus to the client device platform.

20. In a client device platform configured to operate on a network, a method for adding a screen event to an emulated game, comprising:
a) sending an emulation request for a game to an emulator;
b) receiving the emulated game and a screen event stimulus from the emulator, wherein the screen event stimulus is generated by the emulator; and
c) using the screen event stimulus to generate a screen event on the client device platform.

21. The method of claim 20, wherein the screen event is wiggling a displayed image.

22. The method of claim 20, wherein the screen event is changing the brightness of a displayed image.

23. The method of claim 20, wherein the screen event is changing the contrast of a displayed image.

24. The method of claim 20, wherein the screen event is blurring a displayed image.

25. The method of claim 20, wherein the emulation request is sent over the network.

26. The method of claim 25, wherein the network is a wireless connection.

27. The method of claim 25, wherein the network is a wired connection.

28. The method of claim 25, wherein the network is a local area network.

29. The method of claim 25, wherein the network is a wide area network.

30. The method of claim 20, wherein the client device platform is a personal computer.

31. The method of claim 20, wherein the client device platform is a gaming console.

32. The method of claim 20, wherein the client device platform is a hand held gaming console.

33. The method of claim 20, wherein the client device platform includes one or more controllers.

34. The method of claim 33, wherein at least one controller is not configured to generate a haptic response.

35. The method of claim 34, wherein a) further includes sending information to the emulator that indicates at least one of one or more controllers is not configured to generate a haptic response.

36. A nontransitory computer readable medium containing program instructions for adding a screen event to an emulated game, and wherein execution of the program instructions by one or more processors of a computer system causes the one or more processors to carry out the steps of:
a) sending an emulation request for a game to an emulator;
b) receiving the emulated game and a screen event stimulus from the emulator, wherein the screen event stimulus is generated by the emulator; and
c) using the screen event stimulus to generate a screen event on the client device platform.

37. A client device platform configured to operate on a network, comprising:
a processor;
a memory coupled to the processor;
one or more instructions embodied in memory for execution by the processor, the instructions being configured to implement a method adding a screen event to an emulated game, the method comprising:
a) sending an emulation request for a game to an emulator;
b) receiving the emulated game and a screen event stimulus from the emulator, wherein the screen event stimulus is generated by the emulator; and
c) using the screen event stimulus to generate a screen event on the client device platform.
